(19) United States
(12) Patent Application Publication
(10) Pub. No.: US 2022/0203143 A1
(43) Pub. Date: Jun. 30, 2022

(54) Self-Retracting Lifeline Communications Systems

(71) Applicant: 3M INNOVATIVE PROPERTIES COMPANY, St. Paul, MN (US)

(72) Inventors: Matthew J. Blackford, Lake Elmo, MN (US); James P. Gardner, Jr., Stillwater, MN (US); Scott E. Brigham, Maplewood, MN (US)

(21) Appl. No.: 17/595,163

(22) PCT Filed: May 12, 2020
(86) PCT No.: PCT/IB2020/054485

§ 371 Date: Nov. 10, 2021

Related U.S. Application Data
(60) Provisional application No. 62/848,917, filed on May 16, 2019.

(51) Int. Cl. A62B 35/00; G08B 7/06; H04W 4/80; H04W 4/90

(52) U.S. Cl. CPC A62B 35/0043; A62B 35/0037; H04W 4/90; H04W 4/80; G08B 7/06

(57) ABSTRACT

Fall protection equipment, such as a self-retracting lifeline (SRL), including features that enable the SRL to communicate sound to a user or data, or signals to a wireless device.

### TECHNICAL FIELD

The present disclosure relates to improvements in various types of personal protective equipment, and specifically to fall protection equipment.

### BACKGROUND

People working at height, and in particular people whose occupation requires them to work at height, typically use fall protection equipment to mitigate the potential effects of a fall. For example, workers may wear a harness that is attached to a self-retracting lifeline, or SRL, which is in turn attached to a secure attachment point, or anchor point. If a person falls, the SRL stops the payout of the rope or cable connected to the harness, thereby mitigating the effect of the fall. It would be useful to provide certain improvements in this area.

### SUMMARY

Various embodiments are described below, and are in general terms set forth in the claims.

### BRIEF DESCRIPTION OF THE DRAWINGS

Certain features of the present disclosure are described with reference to the appended Figures, in which:

FIG. 1 is a perspective view of a self-retracting lifeline (SRL);

FIG. 2 is side view of a user connected to an SRL;

FIG. 3 is a side view of a user connected to an SRL;

FIG. 4 is a side view of a user connected to an SRL;

FIG. 5 is a schematic view of the components of a communications module;

FIG. 6 is a front view of an SRL positioned at a distance away from a user;

FIGS. 7 and 8 are front views of an SRL, positioned at a distance away from a user; and

FIGS. 9, 10, 11, and 12 are front views of an SRL, positioned at a distance away from a user.

### DETAILED DESCRIPTION

The following description sets forth certain preferred embodiments, but the description is exemplary and not limiting. Variations of the embodiments disclosed below will be apparent to those of skill in the field.

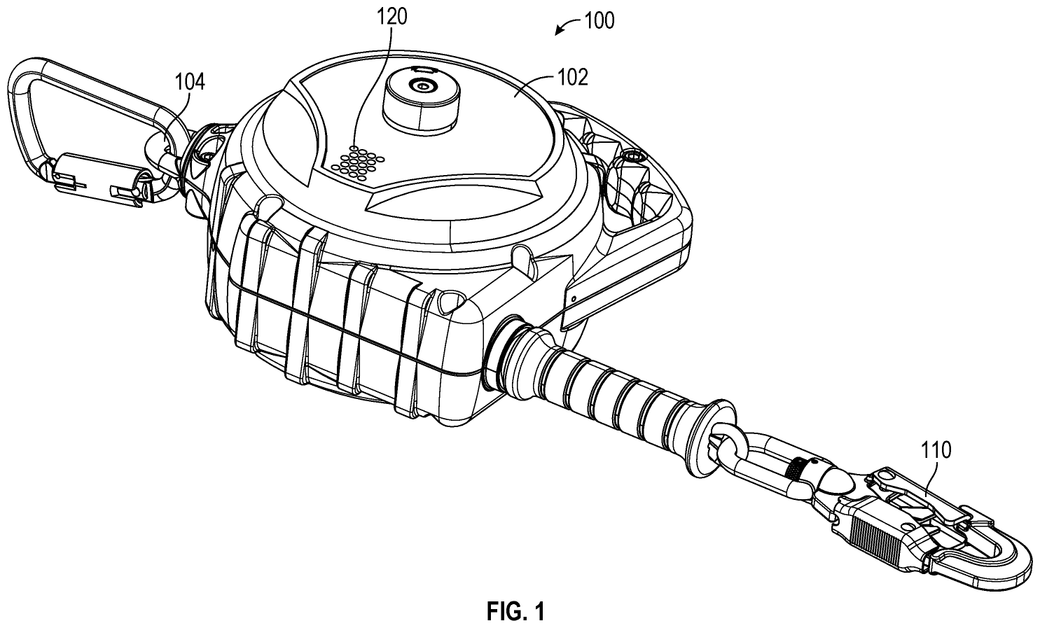

As shown in FIGS. 1, 2, and 3, an SRL 100 according to the present disclosure preferably includes a housing 102 and an anchorage point 104 that can be attached to a fixed structure 106 such as a building, beam, stanchion or static line, either directly, or by a specialized connector. The housing typically surrounds a frame, to which is attached a drum or hub on which a lifeline 108 is gathered. The lifeline may be cable, a strap, a rope, or any other suitable elongate member. Common SRL lifeline lengths include 50 feet (15.25m), 85 feet (25.9m), 100 feet (30.5m), 130 feet (39.6m), and 175 feet (53.3m). Examples of self-retracting lifelines include those sold under the trade designations “ULTRA-LOK”, “NANO-LOK”, and “SMART LOCK” by the Fall Protection Business of 3M Company.

One end of the lifeline is typically attached to the drum, and the free end or distal end of the lifeline is adapted to be connected to a harness work by a user using a snap hook 110. The drum is biased by a spring, such that the lifeline tends to be withdrawn into the SRL and gathered on the drum when the force tending to hold or further withdraw the lifeline (typically exerted by the user) is less than the corresponding torque of the spring tending to retract the lifeline. The terms “user” is specifically meant to include an occupational user, or worker. The user is then free to perform activities while the lifeline extends from and retracts into the SRL automatically, which reduces slack in the line and thereby reduces the potential freefall distance for the user.

The drum, frame, and/or housing includes a mechanism, typically including one or more pawls, arranged to halt the withdrawal of the lifeline in the event of a fall event, to minimize the harm to the user that such an event would otherwise cause. For purposes of the current description, reference may be made to the position of a user, such as a user, or to the position of the distal end of a lifeline. Because the user is typically wearing a safety harness, and the distal end of the lifeline is attached to the harness, the two positions are essentially the same for most purposes. However, some small “personal” self-retracting lifelines include a housing carried by a user and distal end connected to an anchor, as is known in the industry.

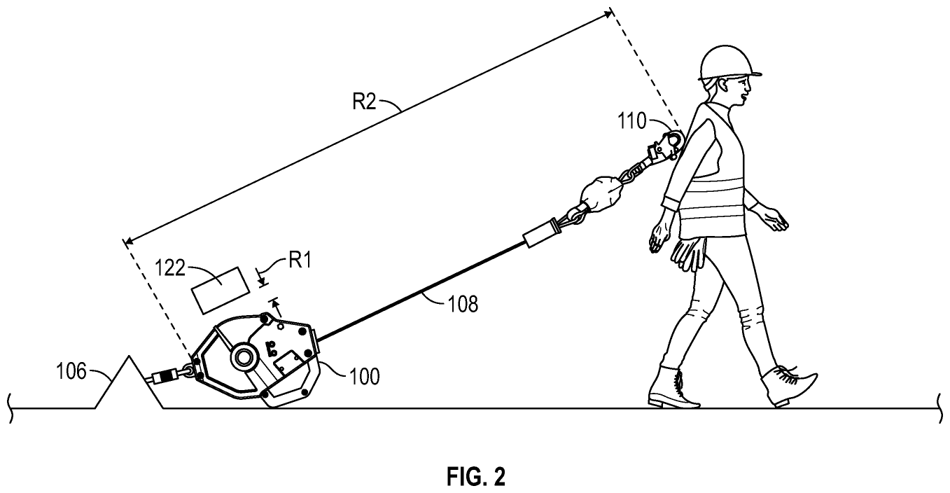

A first feature of the present disclosure relates to an improved ability to notify a user, for example of an unsafe condition. In some embodiments of the present disclosure, the SRL includes a notification device 120, such as an audible or haptic or visual notification device. In one embodiment, the device is a loudspeaker. When designing an SRL, one should consider how far away a user might be located when a notification is generated. For example, if using an audible notification, and an 85 dB notification is thought to be adequate to alert a user, and the user is located within 1 meter of the SRL, then the SRL may be configured to generate an 85 dB sound, or series of sounds. If, however, the user is located at a significant distance away from the SRL, then an 85 dB sound generated at the SRL will be significantly less than 85 dB when it reaches the user. Without intending to be bound by any specific technical theory, it is understood that when the sound level Lₚ₁ is measured at a first distance R₁, then the sound level Lₚ₂ measured at a distance R₂ is given by the following equation (and illustrated in FIG. 2):

$${L}_{p 2} = {L}_{p 1} + 20 {log}_{10} ( {R}_{1} / {R}_{2} )$$

For example, if the sound level Lₚ₂ at the user at a distance R₂ of 15.25 meters (50 feet) is intended to be 85 dB, then the sound measured by sensor 122 at a distance of 1 meter (3.3 feet) from the source should be approximately 109 dB. Self-retracting lifelines are available with lifelines of many different lengths, including one that reaches 61 meters (200 feet), so the approach described herein can be very important in assuring that sounds reach a distant user. The same principles apply to haptic or visual notifications. Any combination of notifications may also be used. Although certain embodiments in the present disclosure are specifically described with reference to audible notifications, the same or similar principles may be applied to haptic or visual notifications.

Because SRLs can be adapted to measure or calculate the length of the lifeline that has been paid out, in some embodiments of the present disclosure the intensity of the notification generated by notification device 120 (such as a loudspeaker) is correlated to the distance that the user is away from the SRL that includes or is connected to that device. In some embodiments an SRL may be provided with a sensor or metering device that can determine how much lifeline has been paid out, optionally a sensor or sensors for determining the direction of and the azimuth angle between the SRL and the user, optionally using the data from the sensor(s) to determine the location of the user (preferably on a continuous basis), optionally comparing that location to a map that represents the work area and is stored in memory associated with the SRL, and then issuing an audible notification or sound prior to or when the user approaches an unsafe condition (which could be based on the map), with the intensity or volume of that sound being correlated to the amount of lifeline that is currently paid out of the SRL. The distance of the distal end of the lifeline may be calculated on a periodic basis, or on a continuous basis.

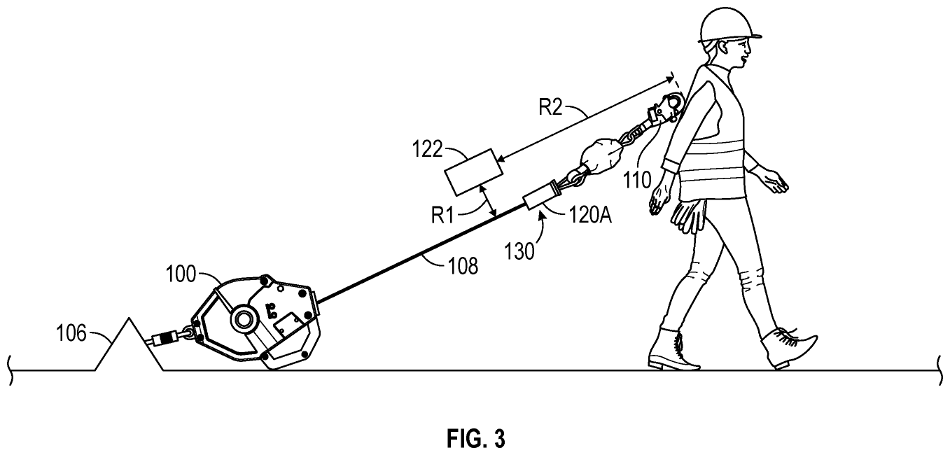

In other embodiments of the present disclosure, a notification arrangement of the type described above could be further improved. In the example described above, although an 85 dB sound may be perceived by a user as loud, but not unpleasant, if another person were standing next to loudspeaker when it emits a 109 dB sound, that person may suffer discomfort or even pain as a result. (A 110 dB sound can be compared to the sound of a jackhammer, or a rock band.) Furthermore, if multiple SRLs are being used in the same area, a loud sound intended to alert one user may be perceived by many nearby users (such as workers on a jobsite), which may cause one or more users to ignore the sounds that are intended to warn them, or to react to sounds not intended to warn them. A solution to these potential problems in some embodiments of the present invention is to relocate the notification device from proximate the SRL housing, to proximate the end of the lifeline that is connected (or connectable) to the user, as shown in FIG. 3 at 120A. In FIG. 3, the notification device 120A is shown as a part of a bumper 130 or other package positioned near the distal end of the lifeline 108. Again, although the notification device may be one that creates an audible notification, the same or similar principles apply relative to a visual or haptic notification being provided near the distal end of the lifeline. In each of these embodiments, the strength of the sound or haptic or visual notification could be adjusted by the user.

Using the calculation methodology described above relative to an audible notification, if r₂ (the distance between the user and the sound source) and r₁ (the distance at which the sound from the sound source is measured) are approximately equal, then the sound that the source is required to produce is approximately the same as the sound that is intended for the user to hear—in the example above, 85 dB. This approach then reduces or eliminates the risk of frightening or potentially hurting another user with an unnecessarily loud sound, as well as the risk of broadcasting the sound in a manner that may cause more people than necessary to hear and react to it, or not react to it.

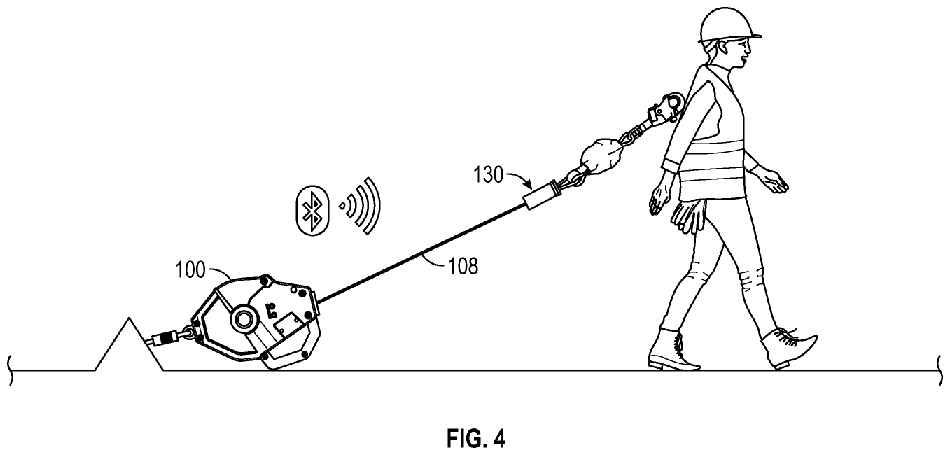

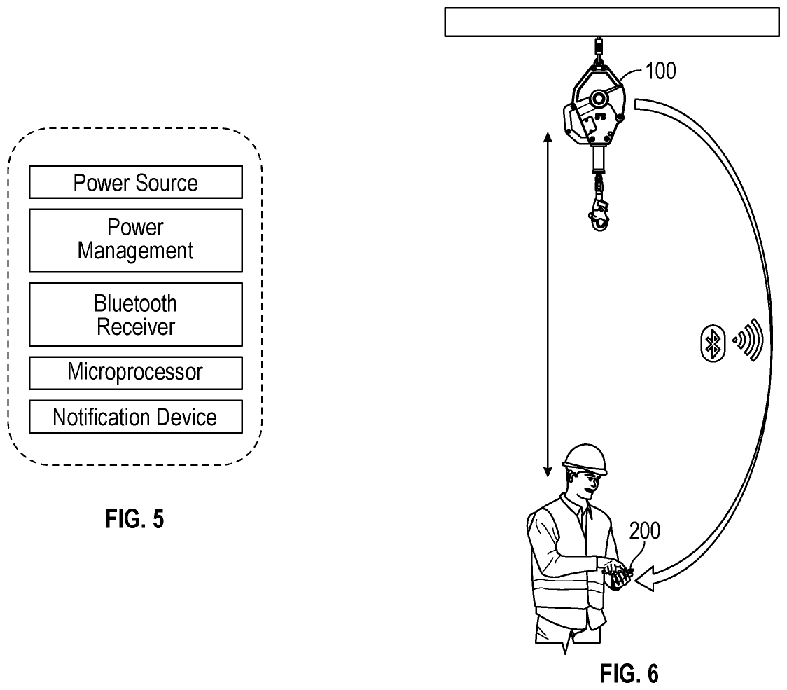

The signal necessary to activate one or more of the audible, haptic, or visual notifications can be transmitted via Bluetooth or other wireless techniques from the SRL to the notification device(s) 120A carried near the end of the lifeline 108, for example in or on a bumper 130 located adjacent a snap hook, as shown in FIG. 4. The “bumper module,” as illustrated schematically in FIG. 5, could include for example a power source, a power management system, a Bluetooth or other wireless receiver (which could also be a transmitter—a transceiver), a microprocessor, and the notification device. It could also include a user interface to enable a user to adjust the notification(s), or other aspects of the system.

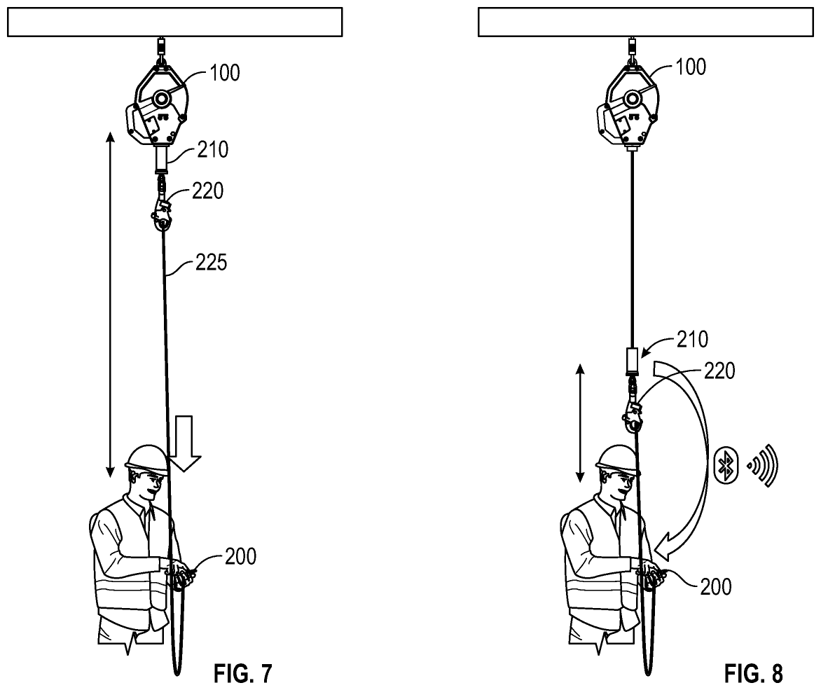

Newer SRLs of the type sold by the Fall Protection Business of 3M Company are sometimes said to be “smart” or “connected” because data (including data of the type described above, such as lifeline extension distance, azimuth angle, and the like) can be collected, stored, and processed by the SRL, and transmitted to a base station or mobile device, or in accordance with embodiments of the present disclosure described elsewhere, a bumper module. In some embodiments, this is preferably done via a wireless link, such as Bluetooth, as shown in FIG. 6. If the user of the lifeline is also the person carrying a mobile device 200 with which the SRL 100 is expected to communicate, then the signals may not be reliably exchanged at distances beyond 50 to 60 feet (15.25m to 18.3m), based on current technology. For example, if a smart SRL 100 is secured to an anchor point 100 feet above a user, it is possible or even likely that data transmitted between the SRL 100 and the mobile device 200 of a user will not be reliably received. This potential problem is addressed by another feature of the present disclosure.

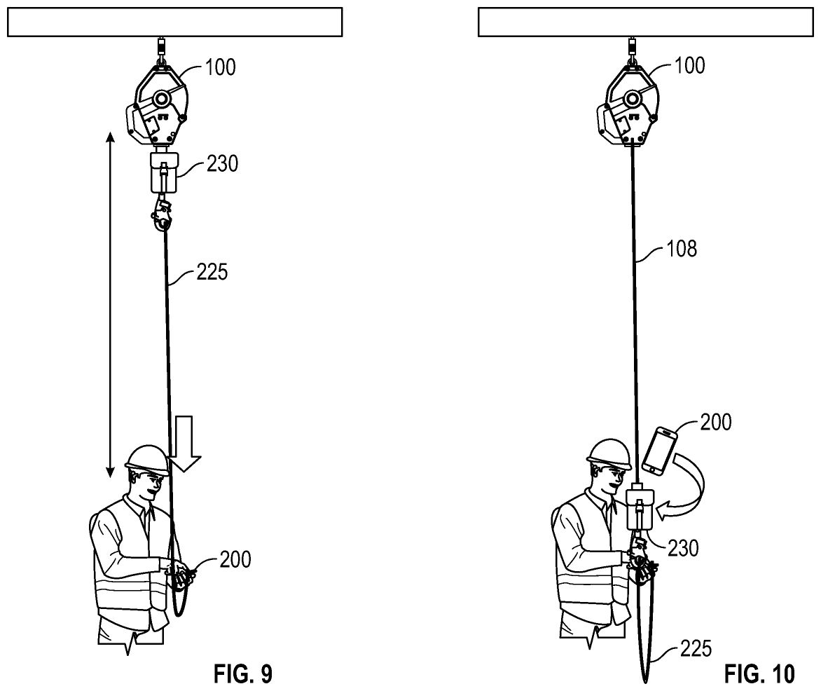

In accordance with some embodiments of the present disclosure, a wireless module 210 is provided at or near the end of the lifeline, for example where a snap hook is positioned, as shown in FIGS. 7 and 8. In a further embodiment, the wireless module 210 may be provided as, or built into, a snap hook bumper module, as described above. The wireless module could comprise a power source, a power management system, a processor, memory, a notification device, and a wireless radio (such as a Bluetooth transmitter), which may also function as a receiver, as shown schematically in FIG. 5. The wireless module 210 (which includes memory) may be thought of as a shuttle, in that when it is within range of the SRL electronic module (including a main memory, typically contained in the SRL housing) as shown in FIG. 7, it communicates with that module, and when it is within range of a mobile device such as a mobile phone carried by a user, as shown in FIG. 8, it communicates with that device. When the module 210 is within range of both the electronic module of SRL 100 and the mobile device 200, it communicates with both. In one particularly useful embodiment, when the lifeline is retracted, the wireless module can obtain information from or transmit information to the SRL, and when the lifeline is extended, the wireless module can transmit information to or obtain information from the mobile device, and vice versa. It may be that the information obtained from the SRI, may be transmitted to the mobile device while the lifeline is in use at another time, and that information obtained by the mobile device while in use be transmitted to the SRL when the lifeline is not in use at another time.

For SRLs that are installed out of reach of a user, it is common industry practice to use a tag line 225 to pull the lifeline and snap hook down to the user. An arrangement of that type is illustrated in FIG. 7. In the context of the present disclosure, the tag line 225 could be used to lower a wireless module 210 carried at or near the end of the lifeline toward a user, where the module could exchange information with a mobile device 200, after which the tag line 225 could be used to allow the lifeline to retract into the SRL 100 at a controlled rate. Once the wireless module is within range of the main memory in or near the SRL, it could exchange information with the main memory.

In another embodiment, a lifeline may be equipped with one or more signal repeaters or range extenders, such as a Bluetooth repeater, that receives, amplifies, and re-broadcasts signals so that data can be exchanged between a mobile device and the main memory in or near an SRL. For example, a signal repeater could be placed in one, two, or more places along the length of a lifeline to facilitate the transfer of data when the lifeline is extended. Although this approach may be challenging with a cable lifeline, flexible circuitry (potentially including a power supply) may be integrated into a web style lifeline, because the web may protect any circuitry or cabling, and be rolled up atop itself when the line is retracted.

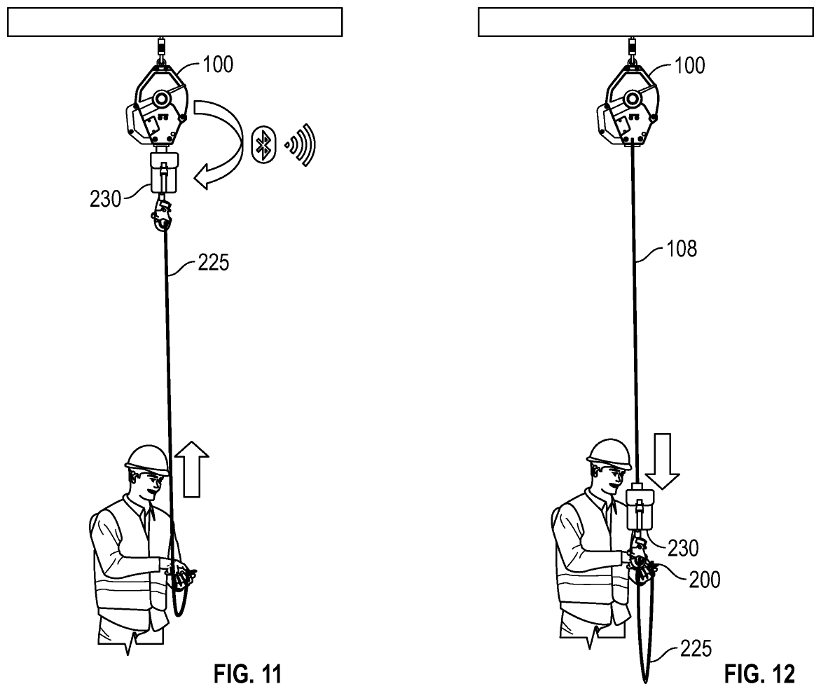

Additional embodiments of the present disclosure also resolve some of the difficulties noted previously in regard to the transfer of data to and from the main memory in or near an SRL from a mobile device carried by a user at a distance from the SRL that exceeds the wireless communications range of the respective devices. One embodiment of the disclosure involves providing a transfer device 230 at or near the end of the lifeline, so that a mobile device may be carried by the transfer device as the lifeline 108 is retracted into the SRL. As shown in FIG. 9, a transfer device 230 (shown as a holder, or sheath) may be affixed at or near the end of a lifeline, and the mobile device 200 (shown as a mobile phone) may be inserted into it. When the lifeline retracts into the SRL, the mobile device approaches the SRL and can exchange data with the main memory when the two are within wireless communications range of each other. The lifeline need not be retracted completely by the SRL, because if the wireless communications range of the two devices is approximately 50 feet (15.25 m), then the lifeline need only be retracted until the two devices are less than that distance apart for data to be exchanged effectively. The mobile devices used in connection with the present disclosure, and/or the SRL, may be equipped to emit one or more sounds, visual indications, or other indications when the other is within wireless communications range, so that a user can determine whether to continue to allow the lifeline to retract into the SRL or not. The lifeline can be extended and retracted via a tag line 225, as noted earlier. The mobile device and/or the SRL may instead or in addition be equipped to emit one or more sounds with the other is no longer within wireless communications range, so as also to notify a user of that fact.

The transfer device may be a sort of closeable pocket or sleeve, as shown, and can be permanently or temporarily attached to the lifeline. For example, the transfer device may be a clip-in or clip-on device into which a mobile device can be snapped, or a closeable folder-type device (which may be useful if the mobile device is a tablet computer, for example). The transfer device should be made of materials that to not substantially block wireless signals.

Various aspects of the present disclosure have been described with reference to certain structures, methods, technologies or options, but many alternatives are possible. For example, although Bluetooth wireless communications may be preferred for certain applications, other wireless technologies such as infrared, ultra wideband, Zigbee, induction wireless, or other systems now known or later developed. Another benefit of various aspects of the present disclosure is the reduction or minimization of power necessary to transmit data over long distances.

Mobile devices include mobile phones, laptop or tablet computers, personal digital assistants, or the like, for example.

Self-retracting lifelines as well known in the field, and may include variations such as those equipped with cables, straps, or ropes, or combinations of the foregoing.

Any suitable type of data could be exchanged in either direction between the main memory associated with an SRL, and the memory of a mobile device, and/or wireless module carried by the lifeline, including the amount of lifeline that has been paid out, the date and time, the angle of the SRL relative to one or more reference directions, information about the area in which the SRL and/or a user may be operating (including the location of potential hazards such as edges, openings, or stairwells), information specific to the SRL (such as the date of its manufacture, or the length of the lifeline, or the date of last inspection or repair of the SRL).

Other data, which may be referred to as configuration data, may be transmitted by a mobile device to the SRL, such as software or firmware updates, updated or new parameters related to operation of SRL, identifiers, dates, inspection data, area data, maps, or setting thresholds, for example. Data transmitted by the SRL housing module to the mobile device could include the firmware version, software parameters, identifiers, GPS location, dates, brake condition, brake activation, reserve line deployment, line extension length, line extension speed, line extension acceleration, number of direction changes, number of pawl locks, number of times exceeding thresholds of any of foregoing, number and dates of inspection(s), and number of fall incidents (as detected by the SRL).

1. A self-retracting lifeline (SRL) comprising:
a. a lifeline having a distal end for connection to a user;
b. a sensor adapted to determine a length of the lifeline that is extended from the SRL;
c. an audible notification device; and
d. a computing device comprising a processor and a memory, the memory including instructions that when executed by the computing device cause the audible notification device to emit sound of an intensity that is correlated to the length of lifeline that is extended from the SRL.

2. The SRL of claim 1, wherein the sound is of a higher intensity when a longer length of lifeline is extended from the SRL than when a shorter length of lifeline is extended from the SRL.

3. The SRL of claim 1, wherein the audible notification device is contained within a housing of the SRL.

4. The self-retracting lifeline of claim 1, wherein the SRL further comprises:
e. a sensor adapted to determine at least one of (i) the direction of a user relative to the SRL and (ii) the azimuth angle between the SRL and the user.

5. The self-retracting lifeline of claim 1, wherein the computing device is adapted to use the data obtained from the sensors to calculate a position of a distal end of the lifeline.

6. The self-retracting lifeline of claim 5, wherein the computing device is adapted to calculate a position of the distal end of the lifeline on a continuous basis.

7. The self-retracting lifeline of claim 6, wherein the computing device is adapted to compare a position of the distal end of the lifeline to a map stored in memory, wherein the map represents a work area.

8. The self-retracting lifeline of claim 7, wherein the SRL is adapted to issue an audible notification prior to or when the user approaches an unsafe condition based on the map.

9-20. (canceled)

21. A self-retracting lifeline (SRL) comprising:
a. a wireless transmitter/receiver proximate a housing of the SRL;
b. a lifeline having a distal end for connection to a user; and
c. a transfer device connected proximate the distal end of the lifeline, the transfer device adapted to receive and carry a mobile device as the lifeline is extended from and retracted into the SRL.

22. The self-retracting lifeline of claim 21, wherein the transfer device is a closeable pocket or sleeve.

23. The self-retracting lifeline of claim 21, wherein the transfer device is made of materials that do not substantially block the transmission of wireless signals.

24. The self-retracting lifeline of claim 21, wherein the SRL further comprises a tag line secured to the distal end of the lifeline, to enable a user to pull the lifeline out of the SRL.

25. The self-retracting lifeline of claim 21, wherein the SRL emits a sound or transmits a notification when a mobile device is within wireless communications range of the SRL.

26-28. (canceled)

29. A method of using a self-retracting lifeline (SRL), comprising the steps of:
(a) determining a length of lifeline extended from the SRL; and
(b) emitting a notification that is proportional to that length.

30. The method of claim 29, wherein the notification is a sound.

31. The method of claim 29, wherein the notification is haptic.

32. The method of claim 29, wherein the notification is visual.

33. A self-retracting lifeline (SRL) comprising:
d. a lifeline having a distal end for connection to a user;
e. a sensor adapted to determine a length of the lifeline that is extended from the SRL;
f. a notification device; and
d. a computing device comprising a processor and a memory, the memory including instructions that when executed by the computing device cause the notification device to emit a sensory notification of an intensity that is correlated to the length of lifeline that is extended from the SRL.

34. The SRL of claim 33, wherein the sensory notification is a sound.

35. The SRL of claim 33, wherein the sensory notification is haptic.

36. The SRL of claim 33, wherein the sensory notification is visual.

37. The SRL of claim 33, wherein the notification is of a higher intensity when a longer length of lifeline is extended from the SRL than when a shorter length of lifeline is extended from the SRL.

38. The SRL of claim 33, wherein the notification device is contained within a housing of the SRL.

39. The self-retracting lifeline of claim 33, wherein the SRL further comprises:
e. a sensor adapted to determine at least one of (i) the direction of a user relative to the SRL and (ii) the azimuth angle between the SRL and the user.

40. The self-retracting lifeline of claim 33, wherein the computing device is adapted to use the data obtained from the sensors to calculate a position of a distal end of the lifeline.

41. The self-retracting lifeline of claim 40, wherein the computing device is adapted to calculate a position of the distal end of the lifeline on a continuous basis.

42. The self-retracting lifeline of claim 41, wherein the computing device is adapted to compare a position of the distal end of the lifeline to a map stored in memory, wherein the map that represents a work area.

43. The self-retracting lifeline of claim 42, wherein the SRL is adapted to issue an audible notification prior to or when the user approaches an unsafe condition based on the map.

44-52. (canceled)
